(19) United States
(12) Patent Application Publication
(10) Pub. No.: US 2024/0124676 A1
(43) Pub. Date: Apr. 18, 2024

(54) RECYCLED POLYMER GRANULATE FOR ADDITIVE MANUFACTURING AND COMPRESSION MOLDING

(71) Applicant: UT-Battelle, LLC, Oak Ridge, TN (US)

(72) Inventors: Matt Korey, Oak Ridge, TN (US); Halil Tekinalp, Oak Ridge, TN (US); Soydan Ozcan, Oak Ridge, TN (US); Peter Wang, Oak Ridge, TN (US); Amber Hubbard, Oak Ridge, TN (US); David Nuttall, Oak Ridge, TN (US); Mitchell Rencheck, Oak Ridge, TN (US)

(21) Appl. No.: 18/380,720

(22) Filed: Oct. 17, 2023

Related U.S. Application Data
(60) Provisional application No. 63/416,621, filed on Oct. 17, 2022.

(51) Int. Cl. C08J 11/06; B29B 9/14; B29C 43/00; B29C 64/314; B33Y 40/10; B33Y 70/10; B33Y 80/00

(52) U.S. Cl. CPC C08J 11/06; B29B 9/14; B29C 43/003; B29C 64/314; B33Y 40/10; B33Y 70/10; B33Y 80/00; C08K 3/04

(57) ABSTRACT

A improved method of additive manufacturing of a recycled granulate is provided. The method comprises providing a starting article. A shredder shreds the starting article to give a shredded product. A granulator shreds the shredded product to give a recycled granulate. The recycled granulate is fed into an additive manufacturing machine. The additive manufacturing machine prints a printed article using the recycled granulate. The method does not comprise a step of compounding the recycled granulate using a twin screw extruder. The starting article, the shredded product, and the recycle granulate each comprise a fiber reinforced polymer composite.

### CROSS-REFERENCE TO RELATED APPLICATIONS

This application claims the benefit of U.S. Provisional Application 63/416,621, filed Oct. 17, 2022, the disclosure of which is incorporated by reference in its entirety.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF THE INVENTION

The present invention relates to methods of additive manufacture and compression molding of articles using recycled polymer granulate for application in aerospace, energy, consumer goods, and transportation.

### BACKGROUND OF THE INVENTION

One key to enabling a circular economy for the plastics industry lies in recycling. Valuable composite materials are seeing a growing industrial demand, resulting in composite shortages, which furthers the need for effective recycling methodologies. A prominent issue with mechanical recycling of thermoplastics and thermoplastic composites is the known degradation of thermomechanical properties with each recycle. Recycling pathways traditionally involve the steps of sorting, shredding, granulating, recompounding, and repelletizing prior to remanufacturing with industrial methods (e.g., compression molding, injection molding). With each mechanical step, the reinforcing fiber (carbon or glass) in thermoplastic composites is shortened and the molecular weight of the polymer decreases, adversely impacting the thermomechanical properties of the recycled composite.

Moreover, composites are a recyclable alternative to thermoset materials, but are currently more expensive than thermoset materials and are thus only used in applications where thermoplastics composites can only be used as feedstock, such as big area additive manufacturing (BAAM) of molds. However, if thermoplastic composites could be produced at costs comparable to thermosets, they could serve as a low-cost, recyclable feedstock for a variety of applications for composites and revolutionize the composites supply chain.

Accordingly, there remains a continued need for cost effective recyclable thermoplastic composites with excellent thermomechanical properties, and in particular, a method for producing recycled composite articles having excellent thermomechanical properties at a competitive cost.

### SUMMARY OF THE INVENTION

An improved method for additive manufacture using a recycled granulate is provided. The method includes shredding a starting article and granulating the shredded product using a granulator to yield a recycled granulate. The recycled granulate is fed into an additive manufacturing machine for printing a three-dimensional article. The starting article, the shredded product, and the recycled granulate each comprise a fiber reinforced polymer composite, which is achieved without the user of a twin screw extruder. In another embodiment, an improved method for compression molding using a recycled granulate is provided. The method includes shredding a starting article and granulating the shredded product using a granulator to yield a recycled granulate. The molding method further includes compression molding a molded article using the recycled granulate. An article manufactured according to the foregoing methods is also disclosed.

These and other features of the invention will be more fully understood and appreciated by reference to the description of the embodiments and the drawings.

### BRIEF DESCRIPTION OF THE DRAWINGS

FIG. 1 is a graphical representation of a fiber reinforced polymer composite recycling processes.

FIG. 2 is a schematic diagram describing single screw plasitcation.

FIG. 3 is a graphical representation of a recycling and additive manufacturing process.

FIG. 4 is a graphical representation of a recycling and additive manufacturing process demonstrating a decrease in molecular weight and tensile modulus as material is more processed.

FIG. 5 is a collection of photographs of (a) virgin CF-ABS pellets, (b) recycled granulate of CF-ABS, (c) a plaque made from virgin CF/ABS pellets, and (d) a plaque made from recycled granulate.

### DETAILED DESCRIPTION OF THE CURRENT EMBODIMENT

As discussed herein, the current embodiments generally relate to a method for additive manufacturing of a recycled granulate. The method generally includes: (a) providing a starting article; (b) shredding the starting article using a shredder to give a shredded product; (c) granulating the shredded product using a granulator to give a recycled granulate; (d) feeding the recycled granulate into an additive manufacturing machine; and (e) printing a printed article from the additive manufacturing machine using the recycled granulate. The method generally does not comprise a step of compounding the recycled granulate using a twin screw extruder. Each such operation is separately discussed below.

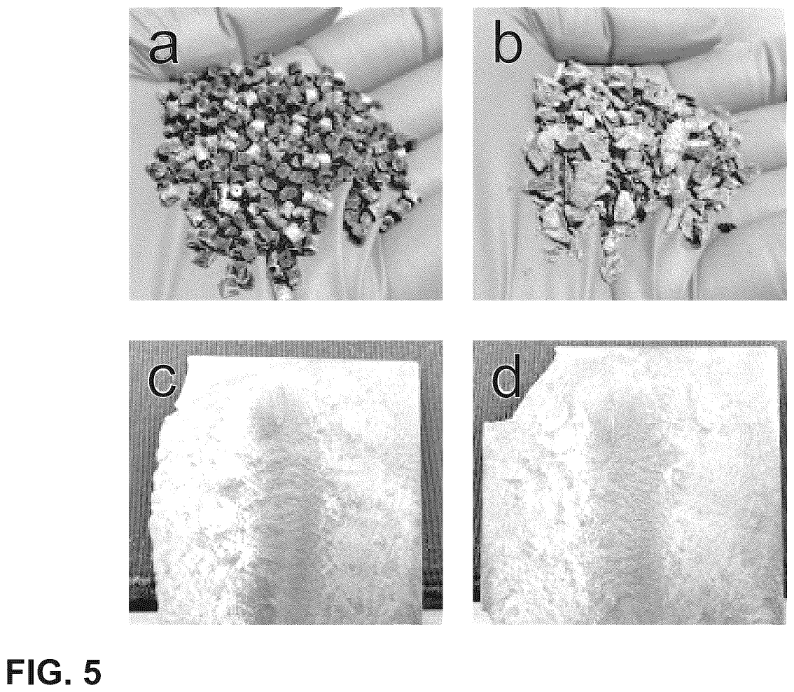

Providing a starting article generally includes providing at least one article comprising a fiber reinforced polymer composite. The fiber reinforced polymer composite is not particularly limited, but can include carbon fiber filled acrylonitrile butadiene styrene (CF-ABS). The starting article can be a manufacturing mold. This step can further include the sub-step of manufacturing the starting article. The starting article can be manufactured from either virgin or recycled materials. In embodiments where the starting article comprises CF-ABS, the starting article can be manufactured from virgin or recycled CF-ABS. Examples of virgin and recycled CF-ABS are shown in FIG. 5. The starting article can be manufactured from the recycled granulate according to the method such that the starting article can be the same article as the printed article or molded article previously manufactured or molded according to one of the disclosed methods. It will be appreciated that in these embodiments the method is a closed loop wherein the printed or molded article of a previous method cycle will be the starting article of another method cycle. This cycle could be repeated indefinitely.

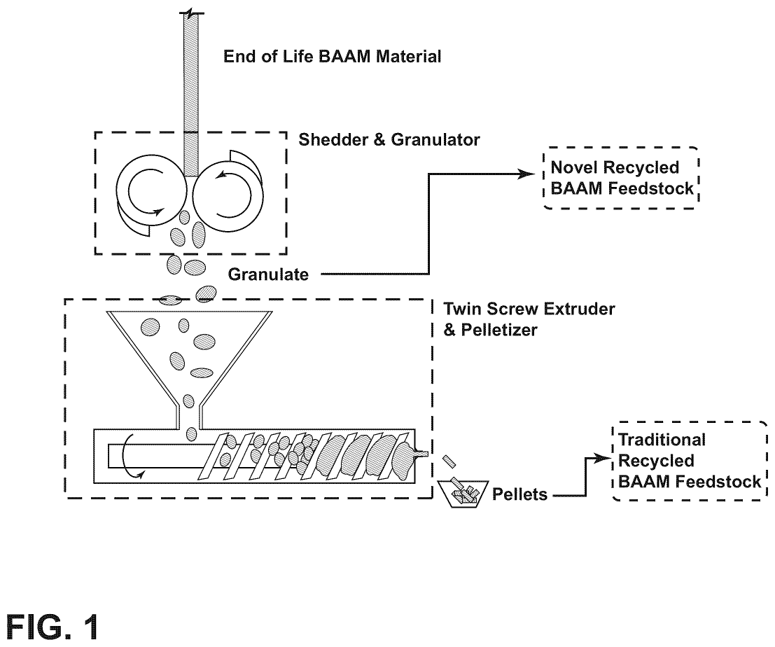

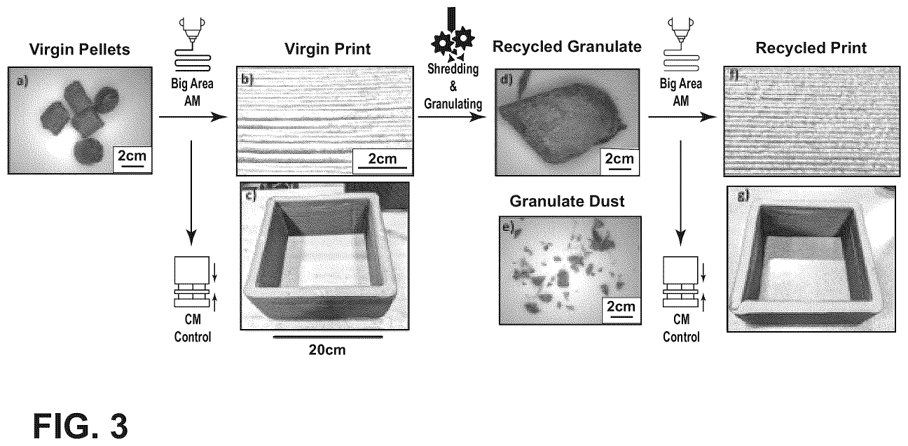

Shredding the starting article using a shredder to give a shredded product is illustrated in FIGS. 1 and 3. Shredding is defined as the tearing or cutting into shreds of an object. The shredding of the starting article is not particularly limited but is generally performed using a shredder. The shredder can be a single-shaft shredder. In specific embodiments, the shredder is a GR280 shredder from Camec S.r.l. The shredded product is not particularly limited, but the shredded product generally comprises a fiber reinforced polymer composite. The fiber reinforced polymer composite can be CF-ABS.

Granulating the shredded product using a granulator to give a recycled granulate is illustrated in FIGS. 1 and 3. Granulating is defined as the process of forming a granulate (or, individually, granules) from a solid substance. Granulating may be mechanically similar to shredding but is primarily distinguished by the reduced size of the resulting granulate when compared to shredded products. In certain embodiments, the granulator is an MG300 granulator system from Camec S.r.l. The shredder and granulator can have a weight throughput of 100-500 kg/hr, alternatively of 200-300 kg/hr, and may be equipped with a mesh size of less than 1 cm, alternatively a 0.635 cm mesh size. The recycled granulate is not particularly limited, but it generally comprises a fiber reinforced polymer composite. The fiber reinforced polymer composite can be CF-ABS. Together, the steps of providing a starting article, shredding the starting article using a shredder to give a shredded product, and granulating the shredded product using a granulator to give a recycled granulate may be referred to herein as “the recycling steps.”

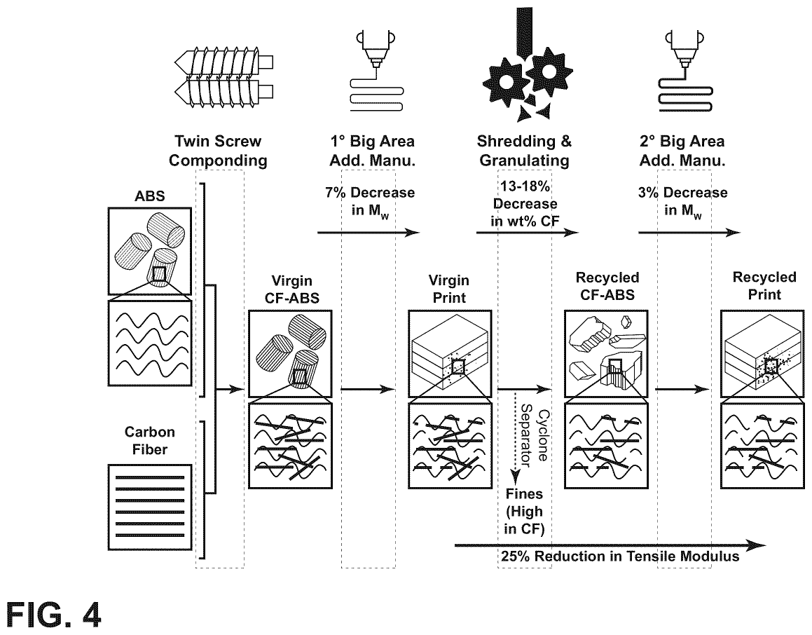

Generally, the method and the recycling steps do not comprise a step of compounding the recycled granulate using a twin screw extruder. Alternatively, the method and the recycling steps do not comprise a step of compounding the recycled granulate at all. In some embodiments, the method and recycling steps do not comprise a step of pelletizing the recycled granulate with a twin screw extruder. Alternatively, the method and recycling steps do not comprise a step of pelletizing the recycled granulate at all. Without being limited to any theory, excluding the steps of compounding and pelletizing the recycled granulate from the recycling steps has several benefits, including reduced economic cost and the excellent thermomechanical performance of printed or molded articles printed or molded using the recycled granulate prepared according to the recycling steps and not comprising the steps of compounding or pelletizing. More specifically, the omission of the compounding and pelletizing steps will reduce the decrease in molecular weight and tensile modulus inherent in mechanical steps as shown in FIG. 4.

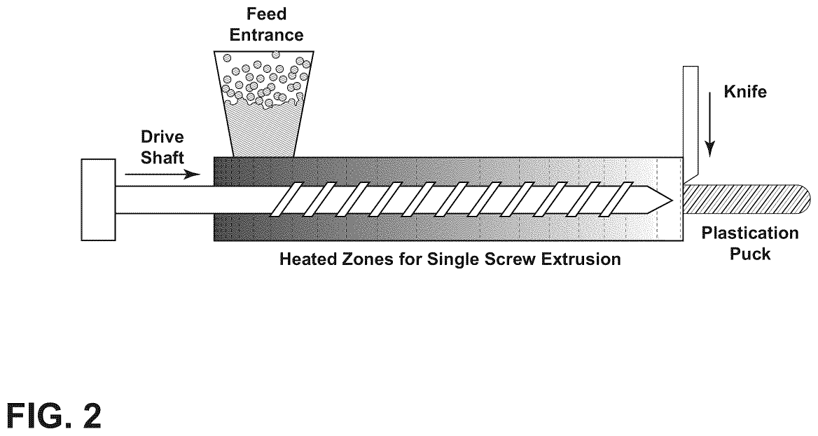

Feeding the recycled granulate into an additive manufacturing machine is illustrated in FIG. 1. Feeding the recycled granulate into an additive manufacturing machine is not particularly limited. In some embodiments, the recycled granulate is fed into the additive manufacturing machine using a vacuum system. The additive manufacturing machine defines a feed entrance and a material outlet. The additive manufacturing machine can be a big area additive manufacturing (BAAM) machine. In specific embodiments, the BAAM machine is a BAAM single screw extruder like the one depicted in FIG. 2. The BAAM single screw extruder comprises a nozzle and a screw. The nozzle can have a diameter of between 5 to 10 mm, alternatively 6 to 8 mm, alternatively 7.62 mm. The nozzle can have a nozzle length of between 1 mm to 200 mm, alternatively 10 to 100 mm, alternatively 40 to 60 mm, alternatively 50.8 mm. The BAAM single screw extruder can have independent heating zones. The independent heating zones are generally distributed along the BAAM single screw extruder such that some are closer to the feed entrance and others are closer to the material outlet.

In some embodiments, the step of feeding the recycled granulate into an additive manufacturing machine further comprises the sub-step of drying the recycled granulate in an oven. The recycled granulate is generally dried in the oven for 5 to 10 hours, alternatively 8 hours, at a temperature of 70 to 100° C., alternatively 80° C.

Printing a printed article from the additive manufacturing machine using the recycled granulate is illustrated in FIGS. 1 and 3. Printing a printed article can involve a sub-step of setting a temperature for each of the BAAM single screw extruder's independent heating zones. Generally, the temperature of an independent heating zone closer to the material outlet will be higher than that of an independent heating zone farther from the material outlet and closer to the feed entrance. The temperature at which any given independent heating zone is set can vary from 100 to 350° C., alternatively from 150 to 300° C. In some embodiments there are five independent heating zones. In these embodiments, the temperature of each of the independent heating zones, in order of closeness to the feed entrance, can be: 177° C., 177° C., 232° C., 250° C., and 250° C. The recycled granulate is extruded from the BAAM single screw extruder at a speed of extrusion and a weight throughput. It will be appreciated that the speed of extrusion and weight throughput will both be related to a screw speed of the screw and dimensions of the BAAM single screw extruder. The screw speed is not particularly limited, but is generally within the range of 20 to 100 RPM, alternatively 30 to 70 RPM, or alternatively 40 to 60 RPM. The weight throughput can be in the range of 1 to 50 kg/hr, alternatively 5 to 20 kg/hr, or alternatively 5 to 10 kg/hr.

The printed article is not particularly limited, but generally comprises a fiber reinforced polymer composite. The fiber reinforced polymer composite can be CF-ABS. In certain embodiments, the printed article is a manufacturing mold. The printed article can be used as the starting article in another cycle of the method. It will be appreciated that in these embodiments the method is a closed loop wherein the printed or molded article of a previous method cycle will be the starting article of another method cycle. This cycle could be repeated indefinitely.

An improved method for compression molding of a recycled granulate is also provided. Generally, the improved method for compression molding comprises the recycling steps described herein. The molding method and the recycling steps do not comprise a step of compounding the recycled granulate using a twin screw extruder. Alternatively, the method and the recycling steps do not comprise a step of compounding the recycled granulate at all. In some embodiments, the molding method and recycling steps do not comprise a step of pelletizing the recycled granulate with a twin screw extruder. Alternatively, the molding method and recycling steps do not comprise a step of pelletizing the recycled granulate at all. Without being limited to any theory, excluding the steps of compounding and pelletizing the recycled granulate from the recycling steps has several benefits, including reduced economic cost and the excellent thermomechanical performance of printed or molded articles printed or molded using the recycled granulate prepared according to the recycling steps and not comprising the steps of compounding or pelletizing. More specifically, the omission of the compounding and pelletizing steps will reduce the decrease in molecular weight and tensile modulus inherent in mechanical steps as shown in FIG. 4.

In some embodiments, the molding method comprises heating the recycled granulate at a temperature for a period of time. The temperature is not particularly limited, but can be from 150 to 300° C., alternatively 200 to 270° C., or alternatively 210 to 230° C. The period of time can be from 30 seconds to 1 hour, alternatively 1 minute to 10 minutes, or alternatively 5 minutes. The step of heating the recycled granulate generally is performed before the step of compression molding a molded article using the recycled granulate.

The molding method generally comprises the step of compression molding a molded article using the recycled granulate. In some embodiments, the step of compression molding a molder article is performed using a hydraulic press. The recycled granulate is pressed at a force. The force can be from 2000 to 15,000 kg, or alternatively 4000 to 6000 kg. The molded article is not particularly limited, but the molded article generally comprises a fiber reinforced polymer composite. The fiber reinforced polymer composite can be CF-ABS. In certain embodiments, the molded article is a manufacturing mold. The molded article can be used as the starting article in another cycle of the method. It will be appreciated that in these embodiments the method is a closed loop wherein the printed or molded article of a previous method cycle will be the starting article of another method cycle. This cycle could be repeated indefinitely.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method of additive manufacturing of a recycled granulate, the method comprising the steps of:
providing a starting article;
shredding the starting article using a shredder to give a shredded product;
granulating the shredded product using a granulator to give a recycled granulate;
feeding the recycled granulate into an additive manufacturing machine without an intermediate extrusion of the recycled granulate; and
printing a printed article from the additive manufacturing machine using the recycled granulate, wherein the starting article, the shredded product, and the recycled granulate each comprise a fiber reinforced polymer composite.

2. The method of claim 1, wherein the fiber reinforced polymer composite is a carbon fiber filled acrylonitrile butadiene styrene (CF-ABS).

3. The method of claim 1, wherein the additive manufacturing machine is a big area additive manufacturing (BAAM) machine.

4. The method of claim 3, wherein the BAAM machine is a BAAM single screw extruder.

5. The method of claim 1, wherein the method does not comprise a step of compounding the recycled granulate.

6. The method of claim 1, wherein the method does not comprise a step of pelletizing the recycled granulate with a twin screw extruder.

7. The method of claim 1, wherein the method does not comprise a step of pelletizing the recycled granulate.

8. The method of claim 1, wherein the starting article is a manufacturing mold.

9. The method of claim 1, wherein the printed article is a manufacturing mold.

10. A printed article manufactured according to the method of claim 1.

11. A method of compression molding of a recycled granulate, the method comprising the steps of:
providing a starting article;
shredding the starting article using a shredder to give a shredded product;
granulating the shredded product using a granulator to give a recycled granulate; and
compression molding a molded article using the recycled granulate without an intermediate extrusion of the recycled granulate; and
wherein the starting article, the shredded product, and the recycled granulate each comprise a fiber reinforced polymer composite.

12. The method of claim 11, wherein the fiber reinforced polymer composite is a carbon fiber filled acrylonitrile butadiene styrene (CF-ABS).

13. The method of claim 11, wherein the step of compression molding a molded article is performed using a hydraulic press.

14. The method of claim 11, wherein the method further comprises a step of heating the recycled granulate.

15. The method of claim 11, wherein the method does not comprise a step of compounding the recycled granulate.

16. The method of claim 1, wherein the method does not comprise a step of pelletizing the recycled granulate with a twin screw extruder.

17. The method of claim 11, wherein the method does not comprise a step of pelletizing the recycled granulate.

18. The method of claim 11, wherein the starting article is a manufacturing mold.

19. The method of claim 11, wherein the molded article is a manufacturing mold.

20. A molded article manufactured according to the method of claim 11.
